(19) United States
(12) Patent Application Publication
(10) Pub. No.: US 2012/0217029 A1
(43) Pub. Date: Aug. 30, 2012

(54) HOLLOW TINE FOR AERATING TURF AND MANUFACTURE METHOD THEREOF

(75) Inventor: Wenlong ZHOU, Guangdong (CN)

(73) Assignee: Shenzhen (China) KM Industrial Co., Ltd.

(21) Appl. No.: 13/033,615

(22) Filed: Feb. 24, 2011

(51) Int. Cl. A01B 45/02; B21D 51/16

(52) U.S. Cl. 172/21; 72/368

(57) ABSTRACT

The patent application discloses a hollow tine for aerating turf. The hollow tine comprises an aerating portion arranged at a front end of the hollow tine for aerating soil; a soil discharging portion arranged at a middle portion of the hollow tine for discharging the soil entered into the aerating portion; and a mounting portion at a back end for connecting to a mechanical power plant. The hollow tine is manufactured by a way of rolling a material plate shaped by shearing. Two sides of the material plate are sheared to be provided with a convex-concave portion respectively. The aerating portion comprises a smooth and seamless wall formed by the convexo-concave portions of the material plate meshed with each other. The hollow tine for aerating turf is made of plate material of high wear resistance and strength, and has a seamless wall and can keep the quality of aerating turf consistent. Furthermore, a manufacture method of the hollow tine for aerating turf is also provided.

### FIELD OF THE PATENT APPLICATION

The patent application belongs to machining technology field and relates to a pipe fitting and manufacture method thereof, and more particularly relates to a hollow tine for aerating turf and manufacture method thereof.

### BACKGROUND OF THE PATENT APPLICATION

A hollow tine is an instrument for turf maintenance. The hollow tine is used for aerating turf with the aid of mechanical equipments, so as to improve the turf's permeability, drainage and metabolic space, and further to promote healthy growth of the turf. Turf maintenance of high quality requires the hollow tine to have fine unearthed capability, high wearable capability, and sufficient mechanical strength. Now, there are three different ways for producing existing international hollow tine. (1) One is manufacturing a hollow tine by the way of extrusion moulding of a steal pipe. Such hollow tine uses a steel pipe as raw material, and after the pressure molding process, mechanical milling process and turning process are performed to manufacture the hollow tine. Accordingly the processes of such hollow tine comprise mechanical milling process which has disadvantages of high cost and low efficiency. Moreover, it is desired for a hollow tine to have high wear resistance and strength. However, the wear resistance and strength of the steel pipe as the raw material is hard to meet the requirements, and there is no choice space. Accordingly, the hollow tine manufactured from steel pipe has poor wear resistance and poor strength. (2) A further one is manufacturing a hollow tine by the way of rolling a steel plate. Particularly, the hollow tine is manufactured by the way of stamping and rolling a steel plate. This hollow tine not only can meet the requirements of strength and wear resistance, but also has advantages of high efficiency and low cost. However, a straight joint will be present after rolling. With the usage of the hollow tine, the inner wall of the hollow tine may be repeatedly extruded by the embedded soil, thus the joint will become wider and wider, which results in great damage to the turf. Accordingly, this hollow tine is only applied to the occasion of turf maintenance having very low quality requirements, and is not suitable for widespread application. (3) Also a further one is manufacturing a hollow tine by the way of the machining of a steel bar which is solid. After mechanical milling process and turning process, a hollow pipe is manufactured from the solid bar. Both its wear resistance and strength can meet the requirements. However, due to the mechanical milling process and turning process, the finish of its inner wall is poor, so the soil discharging can not run smoothly and the quality can not keep consistent, which results in serious damage to the turf. In addition, the consumption of raw material is three times greater than that of the two former types, together with a lot of low efficient machining processes, the production cost will be high.

### SUMMARY OF THE PATENT APPLICATION

The objective of this patent application is to overcome the above problem of prior art, and to provide a hollow tine for aerating turf made of plate material of high wear resistance and strength, such hollow tine has a seamless wall and can keep the quality of aerating turf consistent.

The objective of this patent application is to provide a manufacture method of a hollow tine for aerating turf provided with advantages of simple process, low cost and high production efficiency.

Accordingly to one aspect of present patent application, a hollow tine for aerating turf, comprising:

an aerating portion arranged at a front end of the hollow tine for aerating soil;

a soil discharging portion arranged at a middle portion of the hollow tine for discharging the soil entered into the aerating portion; and

a mounting portion at a back end for connecting to a mechanical power plant;

wherein, the hollow tine is manufactured by a way of rolling a material plate shaped by shearing, two sides of the material plate are sheared to be provided with a convex-concave portion respectively, the aerating portion of the hollow tine comprises a smooth and seamless wall formed by the convexo-concave portions of the material plate meshed with each other.

In the hollow tine for aerating turf, both of the mounting portion and the aerating portion comprise a smooth and seamless wall formed by the convexo-concave portions of the material plate meshed with each other.

In the hollow tine for aerating turf, the convexo-concave portions are provided with protrusions on one side of the material plate and corresponding grooves on the other side, the shapes of the protrusions and the grooves match with each other consistently, and there is no seam between the meshed protrusions and grooves after the rolling shaping.

In the hollow tine for aerating turf, the inner wall of the groove and the outer wall of the protrusion are provided with a smooth transition without an angularity.

In the hollow tine for aerating turf, the groove may be a dovetail groove and the protrusion may be a dovetail wedge corresponding to the dovetail groove; alternatively, the protrusion may be a jagged protrusion and the groove may be a corresponding jagged groove.

In the hollow tine for aerating turf, the protrusion may be a circular, semicircular or irregular protrusion; the groove may be a corresponding circular, semicircular or irregular groove, respectively.

In the hollow tine for aerating turf, the inner and outer surfaces of the hollow tine are smooth and the finish of the surface of the selected raw material plate should meet the requirements of usage.

According to another aspect of the patent application, a manufacture method of the hollow tine is provided, which comprising the following steps:

(1) feed preparation: shearing raw materials into lump materials;

(2) blanking: stamping the lump materials into a material plate with a convexo-concave portion on both two sides on the basis of a designed size;

(3) pre-bending: performing a pre-bending process on the blanked material plate;

(4) rolling: rolling the pre-bent material plate, and butting together the two sides of the pre-bent material plate, meanwhile inlaidly butting together the convexo-concave portions of the two sides, and then forming a pipe fitting;

(5) post-processing: performing joint seamless treatment, heat treatment and surface treatment on the pipe fitting.

In the manufacture method of hollow tine, the step (4) further comprises steps of pre-rolling and Rolling and inlaying; wherein, in the step of pre-rolling, the pre-bent material plate is rolled to be an oval pipe fitting with the convexo-concave portions on the two sides shiplapped with each other; wherein, in the step of Rolling and inlaying, the pre-rolled pipe fitting with the shape of oval is regulated to be a cylindrical pipe fitting, and then the shiplapped convexo-concave portions is pressed into each other to be inlaid together.

In the manufacture method of hollow tine, the joint seamless treatment in step (5) is pressing the joint surface of the rolling and inlaid pipe fitting, so as to deform the joint surface to fill the seam, and then to manufacture a seamless pipe fitting.

The hollow tine according to the present patent application is made of a raw material plate of smooth surface, high wear resistance and high strength, such as a high carbon alloy steel plate by the way of rolling. The aerating portion of the hollow tine comprises a smooth and seamless wall formed by convexo-concave portions of the material plate meshed with the other. As the seam of the aerating portion is formed by convexo-concave portions of the material plate meshed with the other, the tension introduced by meshing may eliminate the influence to the joint resulted from the spring back of the material and the quenching stress produced in the followed heat treatment, also may avoid forming a seam by the extrusion of embedded soil in the usage. The hollow tine according to the present patent application eliminates the seam at the meshed convexo-concave portions to form a smooth and seamless wall, which facilitates aerating and soil discharging smoothly and also ensures the quality of aerating turf and provides a basis for turf maintenance.

Besides employing a seamless joint formed by the convexo-concave portions meshed with each other, the mounting portion is also provided with a seamless joint formed by the convexo-concave portions meshed with each other, which is extrusion resistant and can ensure a high-precision mounting dimensions. The structure described above may ensure the quality of the entire hollow tine and extend the service life, as well as the quality of aerating turf.

To avoid producing a seam at the meshed convexo-concave portions, it is desired that the outer wall of protrusions and the inner wall of grooves have smooth surfaces without an angularity, such that it is easy to be meshed with each other after matching and no seam is left ultimately.

Any shape and form may be utilized for grooves and protrusions according to the present patent application. A shape that can be hooked with each other and can not be directly separated is preferable, for example, the protrusion may use a dovetail wedge protrusion, a circular protrusion and the like, while the groove may correspondingly use a dovetail groove, a circular groove and the like. After meshing, the outer wall of protrusions and the inner wall of grooves are extruded and fastened, so as to avoid problems produced in the usage, such as the influence to the joint resulted from the spring back of the material and the quenching stress produced in the followed heat treatment, also may avoid forming a seam by the extrusion of embedded soil in the usage.

The manufacture method of hollow tine according to the present patent application comprises steps of feed preparation, blanking, pre-bending, rolling and post-processing. A hollow tine with seamless joint is manufactured through above steps. Wherein, in the step of rolling, a pipe fitting is manufactured from a material plate, in which, convexo-concave portions are meshed with each other. In the step of post-processing, a joint seamless treatment is adopted to fill the joint seam formed in the mutual meshing of the convexo-concave portions as to form a seamless pipe fitting with smooth transition. The present patent application has resolved the technical problem that a seam can not be eliminated by the traditional process. As such, the hollow tine according to the present patent application has good performance and the present patent application has advantages of high efficiency, consistent quality, low cost and low consumption of raw materials.

In the step of rolling, firstly, the protrusions and grooves on both sides of the material plate are aligned to be shiplapped, and then an external force is applied to press the protrusions into the corresponding grooves to make the two inlaid together. In the followed post-processing, pressure is applied to the surface of inlaid the protrusions and grooves to produce a plastic deformation so as to fill the seam between the protrusions and grooves, thus completely meshed and seamless convexo-concave portions are achieved.

### BRIEF DESCRIPTION OF THE DRAWINGS

The present patent application is described with reference to the accompanying drawings.

FIG. 1 is a structure schematic view of a hollow tine according to the first embodiment of the present patent application;

FIG. 2 is a structure schematic view of a material plate according to the second embodiment of the present patent application;

FIG. 3 is a structure schematic view of a pre-bent material plate according to the second embodiment of the present patent application;

FIG. 4 is a structure schematic view illustrating the matching between the mould and the material plate during pre-rolling according to the second embodiment of the present patent application;

FIG. 5 is a sectional view of pre-rolled aerating portion according to the second embodiment of the present patent application;

FIG. 6 is a schematic view illustrating the matching between the mould and the pipe fitting during Rolling and inlaying according to the second embodiment of the present patent application;

FIG. 7 is a sectional view of rolling inlaid aerating portion according to the second embodiment of the present patent application.

### DETAILED DESCRIPTION OF THE PREFERRED EMBODIMENT

### Embodiment 1

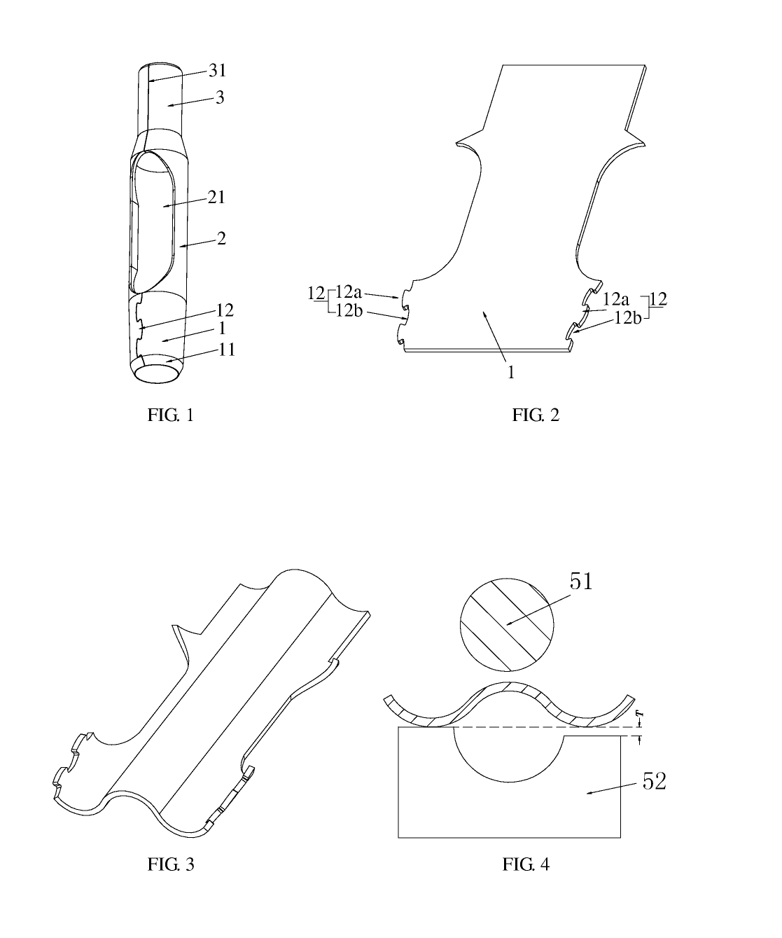

As shown in FIG. 1, a hollow tine comprises an aerating portion 1 arranged at the front end for aerating soil, a soil discharging portion 2 arranged at a middle portion for discharging the soil entered into the aerating portion 1, and a mounting portion 3 at the back end for connecting to a mechanical power plant. The hollow tine is manufactured by the way of rolling a material plate shaped by shearing. Two sides of the material plate are sheared to be provided with a convex-concave portion 12 respectively. The aerating portion 1 comprises a smooth and seamless wall formed by the convexo-concave portions 12 of the material plate meshed with the other. The front end of the aerating portion 1 is shrinking inward gradually by thinning the wall to form incision 11. The incision 11 may facilitate the hollow tine entering into the soil. The soil discharging portion 2 has an opening in the middle of the side wall used for discharging the soil entered into the aerating portion, so as to prevent the hollow tine from being blocked and enable the hollow tine to work continuously. The mounting portion 3 is connected to a mechanical power plant which driving the hollow tine.

Referring to FIG. 1 and FIG. 2, the convex-concave portion 12 comprises a protrusion 12a and a groove 12b, wherein one side of the material plate corresponding to the aerating portion 1 is sheared to be provided with one protrusion 12a, and the corresponding other side of the material plate is sheared to be provided with one groove 12b. The shapes of the protrusion 12a and groove 12b are matched. On each side, the protrusion 12a and the groove 12b are alternately arranged. After the rolling shaping, there is no seam between the protrusion 12a and the groove 12b meshed with each other. Both of the inner wall of the groove 12b and the outer wall of the protrusion 12a are provided with smooth transition and without an angularity. In the embodiment, the groove 12b is a dovetail groove and the protrusion 12a is a dovetail wedge, wherein the dovetail groove and the dovetail wedge are hooked with each other so that the two can not be directly separated. Alternatively, the protrusion 12a can be a jagged protrusion and the groove 12b can be a corresponding jagged groove. Alternatively, the protrusion 12a can be selected from a circular, semicircular or irregular protrusion. To match the protrusion 12a, the groove 12b can be selected from a corresponding circular, semicircular or irregular groove, respectively.

Besides that the aerating porting 1 of the hollow tine is formed as a pipe by the way of the meshing and joining of the provided convex-concave portion 12, the mounting portion 3 can be formed as a pipe by the way of the meshing and joining of its convex-concave portions. That is, the convex-concave portions are also provided on both sides of the material plate corresponding to the mounting portion 3. After rolling, the convex-concave portions are meshed with each other to form a smooth and seamless wall.

In order to facilitate soil discharging and not to damage the turf at the same time, it is desired that both inner and outer surface are smooth, as such the finish of the surface of the selected raw material plate may meet the requirements.

### Embodiment 2

A manufacture method of hollow tine is provided, which comprises the following steps.

(1) Feed preparation: High carbon alloy steel plate with high wear resistance and high strength is selected as raw materials and the high carbon alloy steel plate is sheared into lump materials by a plate shearing machine.

(2) Blanking: the lump materials is stamped into the material plate as shown in FIG. 2 on the basis of designed size, simultaneously, a convex-concave portion is provided on both sides of the material plate corresponding to the aerating portion.

(3) Pre-bending: the pre-bending process of blanked material plate is performed by a mould on a punch, so as to form a bending plate with the shape as shown in FIG. 3.

(4) Pre-rolling: As shown in FIG. 4, a mould is utilized to perform rolling process on a punch, wherein, the mould comprises a cylindrical convex mould 51 and a semi-cylindrical concave mould 52. The concave mould 52 is arranged to have a height difference of T between the two sides, that is, the mould height of one side of the concave mould 52 is larger than that of the other side, and the height difference is T. T is the thickness of the material plate. The stamped material plate is rolled to form a pipe fitting and the convex-concave portion on each side is shiplapped with each other. The cross-section of the aerating portion in the rolled pipe fitting has an oval shape, the cross-section of the soil discharging portion has a U shape, and the cross-section of the mounting portion has a circular shape. FIG. 5 is a sectional view of the aerating portion. As shown in FIG. 5, the protrusion 12a and the groove 12b of the convex-concave portion 12 are shiplapped with each other.

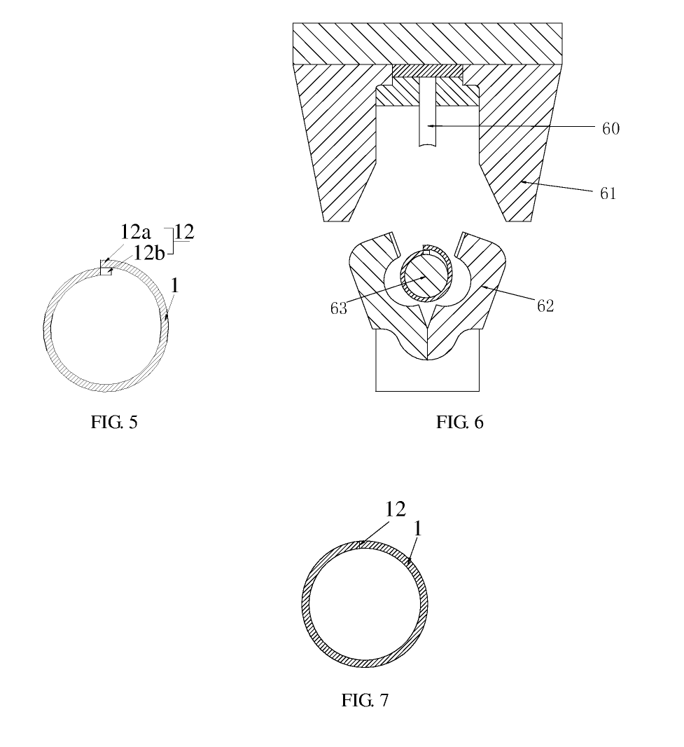

Rolling and inlaying: a Rolling and inlaying process is performed on oval pipe fitting by a mould. As shown in FIG. 6, a corresponding mandrel 63 is put into the pre-rolled pipe fitting and then the two together are put in the swinging concave mould 62. The movement of a wedge 61 in above mould drives the swinging concave mould 62 to rotate around, so as to regulate the pipe fitting from an oval shape to a circular shape. The pipe fitting is clamped so that a groove on one side is corresponding to the location of a protrusion on the other side. The protrusion is pressed into the groove by the downward movement of the convex mould 60, so as to achieve the inlaid butt between the rolled convex-concave portions, as shown in FIG. 7. The rolled convex-concave portions meshed with each other are provided with smooth transition and without an angularly protrusion.

(5) Post-processing: Joint seamless treatment, heat treatment and surface treatment are performed on the pipe fitting.

Joint seamless treatment: the joint surface of the rolling and inlaid pipe fitting is pressed, so as to deform the joint surface to fill the seam, and then to manufacture a seamless pipe fitting. To ensure the inlaying between the convex-concave portions run smoothly, a seam of 0.02 mm is reserved between the protrusion and the groove of convex-concave portions during blanking. To eliminate the seam, a pressure is applied on the metal surface of the inlaid region to produce a plastic deformation. Resulted from that, the metal in the inlaid portion is flowable to fill the seam between the convex-concave portions, such that the completed meshing without seam is realized.

Heat treatment: In the high temperature furnace, the pipe fitting is heated to 810° C.˜850° C. and then preserved at the temperature (the preserving time is dependent on the number of workpiece). Followed that, oil quenching, tempering at 350° C. and air cool are implemented successively to achieve a workpiece with hardness of HRC500.

Surface treatment: Finally, a rust-proof treatment is applied on the hollow tine, wherein, the hollow tine may be immersed into the antirust oil; or a blackening may be implemented on the hollow tine.

The ultimate hollow tine as shown in FIG. 1 is manufactured ultimately.

What is claimed is:

1. A hollow tine for aerating turf, comprising:
an aerating portion arranged at a front end of the hollow tine for aerating soil;
a soil discharging portion arranged at a middle portion of the hollow tine for discharging the soil entered into the aerating portion; and
a mounting portion at a back end for connecting to a mechanical power plant;
wherein, the hollow tine is manufactured by a way of rolling a material plate shaped by shearing, two sides of the material plate are sheared to be provided with a convex-concave portion respectively;
the aerating portion of the hollow tine comprises a smooth and seamless wall formed by the convexo-concave portions of the material plate meshed with each other.

2. The hollow tine for aerating turf of claim 1, wherein both of the mounting portion and the aerating portion comprise a smooth and seamless wall formed by the convexo-concave portions of the material plate meshed with each other.

3. The hollow tine for aerating turf of claim 1, wherein the convexo-concave portions are provided with protrusions on one side of the material plate and corresponding grooves on the other side, the shapes of the protrusions and the grooves match with each other consistently, and there is no seam between the meshed protrusions and grooves after the rolling shaping.

4. The hollow tine for aerating turf of claim 2, wherein the convexo-concave portions are provided with protrusions on one side of the material plate and corresponding grooves on the other side, the shapes of the protrusions and the grooves match with each other consistently, and there is no seam between the meshed protrusions and grooves after the rolling shaping.

5. The hollow tine for aerating turf of claim 3, wherein the inner wall of the groove and the outer wall of the protrusion are smooth surface without an angularity.

6. The hollow tine for aerating turf of claim 4, wherein the inner wall of the groove and the outer wall of the protrusion are smooth surface without an angularity.

7. The hollow tine for aerating turf of claim 1, wherein the groove may be a dovetail groove and the protrusion may be a dovetail wedge corresponding to the dovetail groove; alternatively, the protrusion may be a jagged protrusion and the groove may be a corresponding jagged groove.

8. The hollow tine for aerating turf of claim 2, wherein the groove may be a dovetail groove and the protrusion may be a dovetail wedge corresponding to the dovetail groove; alternatively, the protrusion may be a jagged protrusion and the groove may be a corresponding jagged groove.

9. The hollow tine for aerating turf of claim 1, wherein the protrusion may be a circular, semicircular or irregular protrusion; the groove may be a corresponding circular, semicircular or irregular groove, respectively.

10. The hollow tine for aerating turf of claim 2, wherein the protrusion may be a circular, semicircular or irregular protrusion; the groove may be a corresponding circular, semicircular or irregular groove, respectively.

11. The hollow tine for aerating turf of claim 1, wherein the inner and outer surfaces of the hollow tine are smooth.

12. The hollow tine for aerating turf of claim 2, wherein the inner and outer surfaces of the hollow tine are smooth.

13. A manufacture method of the hollow tine, comprising the following steps:
(1) feed preparation: shearing raw materials into lump materials;
(2) blanking: stamping the lump materials into a material plate with a convexo-concave portion on both two sides on the basis of a designed size;
(3) pre-bending: performing a pre-bending process on the blanked material plate;
(4) rolling: rolling the pre-bent material plate, and butting together the two sides of the pre-bent material plate, meanwhile inlaidly butting together the convexo-concave portions of the two sides, and then forming a pipe fitting;
(5) post-processing: performing joint seamless treatment, heat treatment and surface treatment on the pipe fitting.

14. The manufacture method of hollow tine of claim 13, wherein, the step (4) further comprises steps of pre-rolling, and Rolling and inlaying; wherein, in the step of pre-rolling, the pre-bent material plate is rolled to be an oval pipe fitting with the convexo-concave portions on the two sides shiplapped with each other; wherein, in the step of Rolling and inlaying, the pre-rolled pipe fitting with the shape of oval is regulated to be a cylindrical pipe fitting, and then the shiplapped convexo-concave portions is pressed into each other to be inlaid together.

15. The manufacture method of hollow tine of claim 13, wherein, the joint seamless treatment in step (5) is pressing the joint surface of the rolling and inlaid pipe fitting, so as to deform the joint surface to fill the seam, and then to manufacture a seamless pipe fitting.
